(19) United States
(12) Patent Application Publication
(10) Pub. No.: US 2019/0032905 A1
(43) Pub. Date: Jan. 31, 2019

(54) Artificial Holiday Tree

(71) Applicant: Christmas Northeast, Inc., Trumbull, CT (US)

(72) Inventor: James W. Gibboney, JR., Suches, GA (US)

(73) Assignee: Christmas Northeast, Inc.

(21) Appl. No.: 15/658,471

(22) Filed: Jul. 25, 2017

(51) Int. Cl. F21V 23/06; A47G 33/06; A47G 33/08; F21V 29/50; F21S 4/10; F21V 23/00; H01R 13/62

(52) U.S. Cl. CPC F21V 23/06; A47G 33/06; A47G 33/08; F21V 29/50; F21W 2121/04; F21V 23/002; H01R 13/6205; A47G 2033/0827; F21S 4/10

(57) ABSTRACT

An artificial tree includes a base supporting a hollow trunk. The base includes plural legs connected to a central core. The base carries a housing containing an electrical controller for transforming, rectifying, and filtering electrical power received from a power receptacle. The housing includes a heat pump to dissipate heat from the electrical controller. A series of interconnected conduits comprises the tree trunk. Each conduit has two identical electrical connectors that self-orient by magnetic repulsion to preserve electrical parity when connecting conduits together. Wiring harnesses run between the two electrical connectors in each conduit. The outside surface of the conduits carries hinge brackets to receive and pivotally hold artificial limbs. These limbs carry light strings and are pivotable between folded and deployed orientations. Wires from the wiring harness are pulled through holes in the sides of the conduits and connect to light strings on nearby limbs.

### TECHNOLOGY FIELD

This disclosure relates to the field of artificial holiday trees, including lighted artificial holiday tree.

### BACKGROUND

For a variety of reasons, artificial trees such as those used for decorating at holidays have become more popular over time. These trees are increasingly more realistic-looking, that is, they looking more like natural evergreen trees than in the past, and many are made to include holiday-type lights, such as small incandescent lights or light-emitting diodes (LEDs) arranged to be in series electrically or in a series-parallel electrical configuration.

Despite improvements in appearance, artificial trees may still benefit from improvements. A better artificial tree would be advantageous.

### SUMMARY

Herein is disclosed an artificial tree that includes a base that supports a hollow trunk. A feature of the disclosure is the artificial tree trunk, which has an interior and an exterior surface with hinge brackets carried by the exterior surface to serve as supports for the limbs. Limbs are received by the hinge brackets, one limb to each such hinge bracket and are secured to their brackets. Brackets may be hinge brackets so that each limb is pivotable between a cantilevered position away from the exterior of the trunk and a position generally more parallel to the exterior surface of the artificial tree trunk, which is convenient for storage or shipping. Still another feature of the disclosure is the electrical power connections and an electrical power distribution system carried throughout the interior of the hollow trunk and on to the limbs to bring electrical power operatively to lighting carried by the limbs.

The tree also has an electronic controller and a heat pump, which are in a housing carried by the base, a feature of the disclosure. The electronic controller is connected between the electrical power connection and the electrical power distribution system. The electronic controller conditions, regulates and controls electrical power delivered to the lighting on the artificial tree. The heat pump helps to dissipate heat generated by the electronic controller and does so in part through the base, including housing, legs, upper supports braces and central core, another feature of the disclosure, which are made of a heat conducting material.

The base has plural legs include surface-engaging feet and a framework made of solid and hollow heat-conducting material connected to a central core that is attached to the hollow trunk using eyebolts. The hollow trunk of the artificial tree may be made of conduits joined together, for example, by inserting the end of one conduit into another conduit. The base and hollow trunk are features of the disclosure.

Inside the conduits that comprise the tree trunk may be magnetic repulsion connectors, one at each end perhaps with one such connector recessed from an end of a magnetic repulsion connector and another inserted flush with the end of the next magnetic repulsion connector so the two readily make electrical contact, according to features of the disclosure.
Still another feature of the disclosure is that the trunk of the artificial tree 10 may have plural holes formed in it, each fitted with a grommet so that electrical conductors may be pulled through the holes easily and then joined to electrical light strings wound around the limbs. The electrical conductors may be included in a wiring harness including plural electric wires running from one magnetic repulsion connector in the conduit to the other magnetic repulsion connector.

Many other features of the artificial tree disclosed herein will be apparent to those skilled in the art of artificial trees from a careful reading of the detailed description accompanied by the drawings.

### BRIEF DESCRIPTION OF THE DRAWINGS

In the figures,

FIG. 1 is a perspective view of an artificial tree to show its base, heat pump, and trunk formed of joined conduits, according to an aspect of the disclosure;

FIG. 2 is a side view of the base of FIG. 1 with the housing of the heat pump cutaway to show its interior and the electronic controller;

FIG. 3 is a cross-sectional view of conduits connected together with magnetic repulsion connectors in contact and the electrical wiring harness between them, according to an aspect of the disclosure;

FIG. 4 is an exterior view of a tree trunk with hinge brackets for limbs and electrical conductors extending through holes in the conduit; and

FIG. 5 is a cross-sectional view of a tree trunk with hinge brackets deployed to receive limbs and electrical wires extending through a hole in the conduit to connect with light strings pre-strung to a limb, according to an aspect of the disclosure.

### DETAILED DESCRIPTION

In the present disclosure, the terms “trunk” and “limbs” are used in connection with structures in an artificial tree 10 that are by direct analogy to the trunk and limbs of a natural tree 10. Also, portions of the present disclosure incorporate components based on those disclosed in U.S. Pat. Nos. 9,614,322 and 9,033,777, which are both incorporated by reference in their entirety.

This disclosure teaches an artificial tree 10, that is, a manufactured product that resembles a natural tree but is not a natural, grown tree but a replica designed to simulate a natural tree in appearance. The present artificial tree 10 may be used, for example, during holidays with lighting and ornamentation as a Christmas tree.

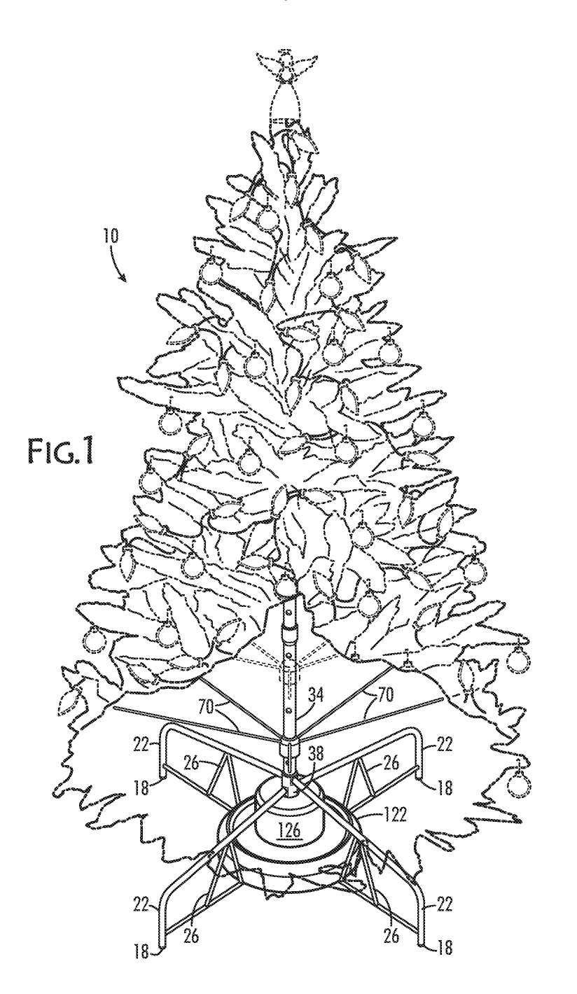

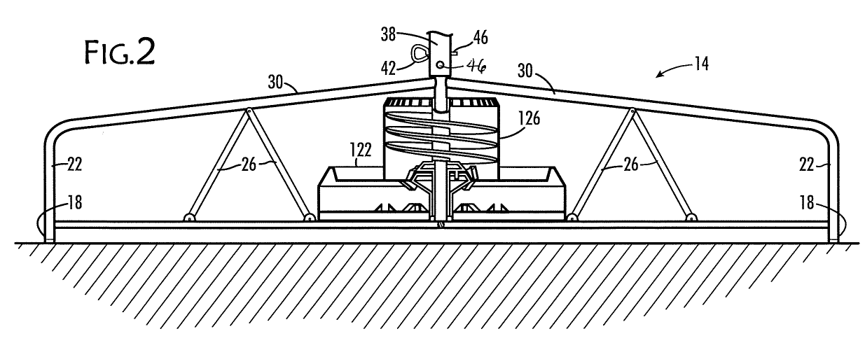

The artificial tree 10, illustrated in FIG. 1 and details of which are illustrated in FIGS. 2-5, includes a base 14 14 the primary function of which is to hold the artificial tree 10 in a vertical orientation, that is, in the natural (i.e. vertical) orientation a natural tree would grow. Base 14 14 has an additional function associated with heat dissipation. Base 14 14 may be made of at least three legs 2218 extending radially from a central core. Each leg 22 may be made of a combination of solid and hollow members that are selected and connected to have sufficient strength, collectively, to hold the tree 10, including whatever may be hung from it, in a stable, vertical orientation.

Base 14 also has surface-engaging feet 18 that are at the ends of each leg 22 of at least three legs 22 and may elevate other parts of the base 14 off the surface on which the surface-engaging feet 18 are otherwise engaged. Horizontal and diagonal braces 26 may be used to stiffen upper supports 30 of legs 22, as best seen in FIG. 2.

A trunk 34 of artificial tree 10, made of at least one conduit 50, is received within a central core 38 of base 14. Trunk 34 may thereafter be prevented from rotation with respect to central core 38 in any convenient manner. For example, a fastener 42, which may be a threaded eyebolt, may be inserted through a hole 46 near the top of central core 38. Trunk 34 comprises plural conduits 50, such as one conduit 50 for every meter of the height of artificial tree 10. Fastener 42 may engage the side of the first, or bottom-most, conduit 50 extend into a hole 54 to lock both central core 38 and conduit 50 together.

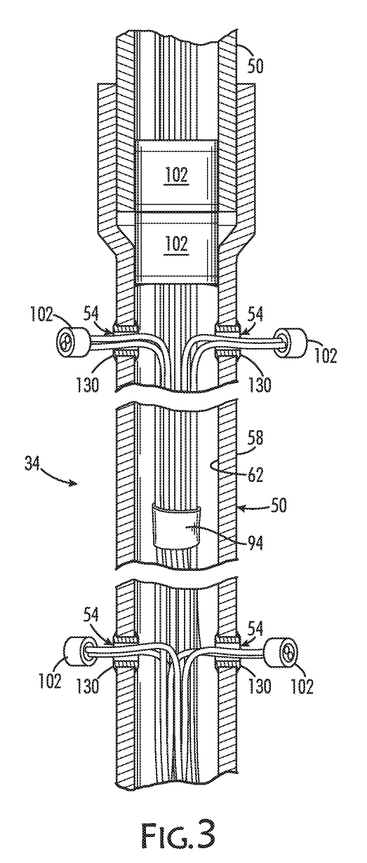

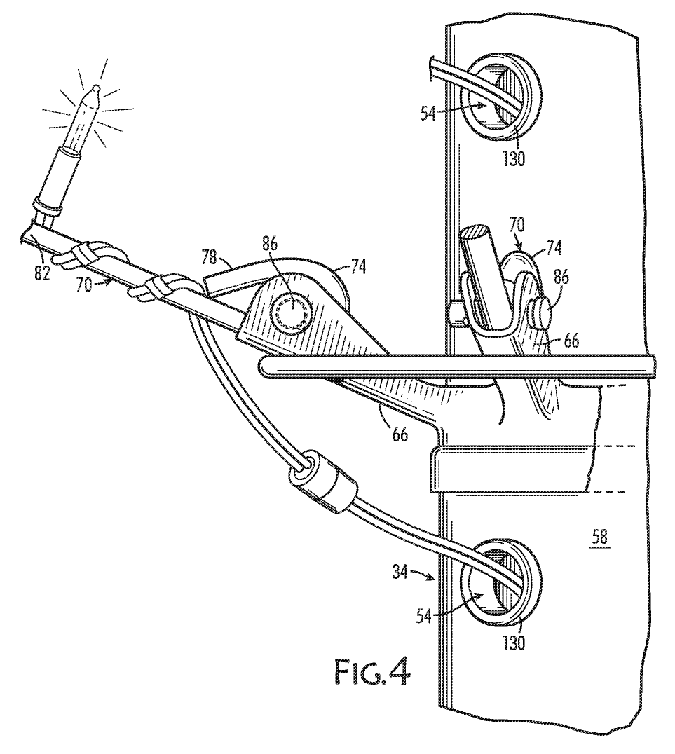

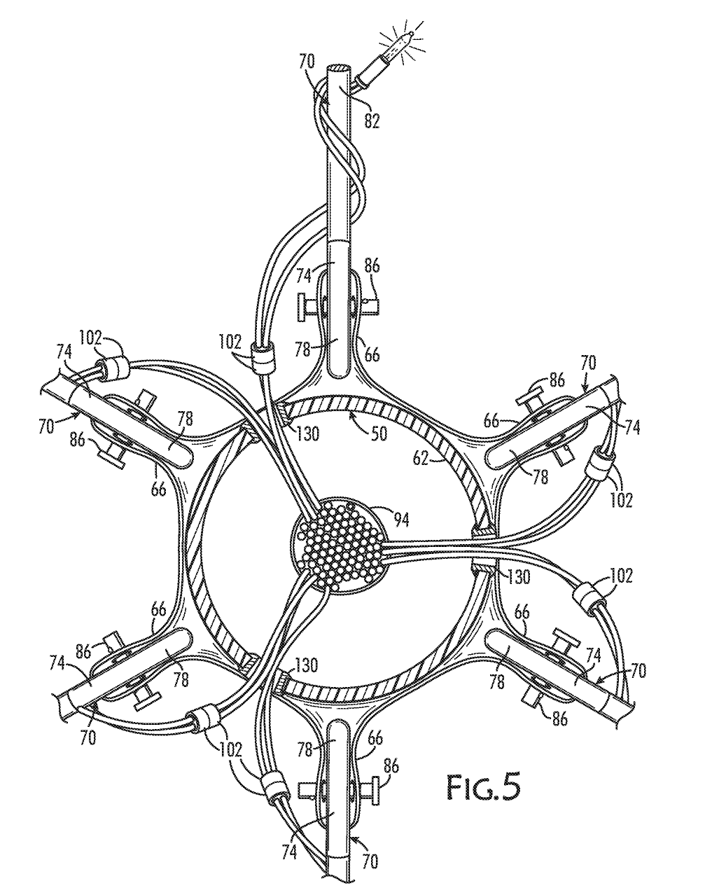

Referring now to FIGS. 3 and 5, trunk 34 is hollow and has an exterior surface 58 and an interior surface 62. On exterior surface 58, as shown in FIG. 4, are hinge brackets 66. There may be several hinge brackets 66 on exterior surface 58 of each conduit 50 and each hinge bracket 66 may be deployed about exterior surface 58 in any number and arrangement. Hinge brackets 66 may be arranged, for example, in clusters at different elevations up exterior surface 58 each conduit 50, such as three to six hinge brackets 66 in a single cluster and three to five clusters per conduit 50.

Hinge brackets 66 receive limbs 70, one limb 70 of plural limbs 70 in each hinge bracket 66 of plural hinge brackets 66. Limbs 70 are rotated from a nearly parallel orientation to a cantilevered orientation with respect to trunk 34 by hinge brackets 66. Accordingly, hinge brackets 66 need to be strong enough and secured well enough to hold limbs 70 play any lighting and decorations the user wishes to add to limbs 70. A suitable hinge bracket 66 is curved for strength and allows a proximal end 74 of each limb 70 to nest inside the curve of hinge bracket 66.

A loop 78 may be formed in limb 70 by bending proximal end 74 back on itself. Proximal end 74 is the end that is closest to trunk 34 when limb 70 is insertable in hinge bracket 66; a distal end 82 of limb 70 extends away from trunk 34 when limb 70 is in its normal, cantilevered orientation. Hinge bracket 66, being curved, may be formed so as to receive a pin 86 passing through the two sides of hinge bracket 66 at the point where loop 78 is formed and limb 70 is nested between the two sides of hinge bracket 66, thereby trapping limb 70 between the two sides of hinge bracket 66, and allowing limb 70 to be pivoted about pin 86. In that position, limb 70 is held securely to trunk 34 by hinge bracket 66 and is otherwise free to pivot between a cantilevered position extended radially from trunk 34 and its stored position nearly parallel to trunk 34 of artificial tree 10. The stored position may be suitable for storage and shipping of artificial tree 10 because of its more compact configuration.

As shown in FIG. 2, each conduit 50 is generally cylindrical and may be secured, end-to-end, to another conduit 50. Conduits 50 may be secured by a coupling (not shown) that joins two conduits 50 or by inserting the end of one conduit 50 into the expanded end of a next conduit 50, as shown in FIG. 3.

Conduit 50 contains two magnetic repulsion connectors 90 as shown and described in U.S. Pat. No. 9,614,322, cited above. Magnetic repulsion connectors 90 are identical to each other and self-orient by magnetic repulsion. Only after magnetic repulsion connectors 90 of two different conduits 50 are properly oriented will magnetic repulsion connectors 90 be able to make physical connection. When connected, they also maintain electrical polarity.

As two conduits 50 are moved toward each other and rotated axially into position, the terminals of the two magnetic repulsion connectors 90 remain inside their respective channels. Once magnetic repulsion connectors 90 correctly align, one movable terminal of each magnetic repulsion connector 90 is drawn toward the fixed terminal of the other magnetic repulsion connector. The moving terminal rises slightly above the end of its channel and into the channel of the non-moving terminal of other magnetic repulsion connector 90. This movement, in addition to making physical and electric connection across the proper terminals of the opposing magnetic repulsion connectors 90, also makes it more difficult for lateral forces to dislodge both magnetic repulsion connectors 90.

A wiring harness 94 connects to magnetic repulsion connectors 90 inside conduit 50. Wiring harness 94 will include groups of wires 98 that run from one magnetic repulsion connector 90 to another magnetic repulsion connector at the opposing end of the same conduit 50 and groups of wires that may terminate at one end in a smaller magnetic repulsion connector 102. Magnetic repulsion connectors 102 are pulled through a hole 106 in the side of conduit 50 and left until needed. Hole 106 may be fitted with a grommet 130 to protect wires 98 from sharp edges of the conduit's side walls.

Alternatively, these wires 98 could be in paired sets. For example, there could be three holes 106 in conduit 50 instead of six holes 106 with two sets of wires 98 running through each of the three holes 106, or three sets of wires 98 coming out of only two holes 106. Another alternative is to provide one hole 106 with one set of wires 98 going to lighting sets on a first limb 70, and, to connect that set of wires 98 to a jumper wire 110 that runs to a second limb 114, and to connect additional jumper wires running to the remaining limbs 70 of that cluster. Accordingly, lights of limb 70 receive primary power and the rest of the lights on the other limbs 70 in that cluster are connected in an electrical series/parallel arrangement, with each limb 70 in parallel to the next limb 70 in the cluster, and the lights on limbs 70 of other clusters are in series the first cluster. Wiring may thus be reduced, which results in a reduced cost.

The exterior surface 58 of conduits 50 carry hinge brackets 66 that receive limbs 70. Limbs 70 are pre-wired for lighting, which terminates in magnetic repulsion connector 102 near the hinge bracket 66. A magnetic repulsion connector 102 on the end of the wires running from inside conduit 50 may be connected to another magnetic repulsion connector 102 on the end of the group of wires from a light string set (not shown) on limb 70 of artificial tree 10 to power that light string.

Magnetic repulsion connectors 102 may be magnetic repulsion connectors such as those shown and described in U.S. Pat. No. 9,614,332, referenced above. Each light string on limb 70 may terminate in magnetic repulsion connector 102. Each limb cluster could have lighting that terminates in the same type of magnetic repulsion coupler 102 and which can be then be connected to another such magnetic repulsion connector 102 that terminates the pair of wires coming through hole in conduit 50 from wiring harness for electrical power. If magnetic repulsion connectors are used where there is magnetic repulsion connector 102 per limb 70, then each limb 70 would have its own separable lighting system. Additionally, these magnetic repulsion couplers 102 are easily disconnected. Here, hinge bracket 66 has a pin 86 that passes through loop 78. By pulling pin 86 from hinge bracket 66, limb 70 may be removed. As limb 70 is removed, magnetic repulsion connector 102 self-disconnects from the corresponding magnetic repulsion connector 102 from wiring harness 94 in conduit 50. In the event the lights on limb 70 or other aspect of limb 70 fails or breaks, the entire artificial tree 10 does not have to be replaced. Instead, only limb 70 is replaced. The replacement limb 70 is inserted into hinge bracket 66 and pin 86 is inserted. Then, the magnetic repulsion connector 102 is connected to magnetic repulsion connector 102 from the conduit.

At the bottom of the artificial tree 10, running into the base 14, is an electrical power connection, such as a plug 118 that is insertable into a wall socket to access commercial or residential power, for example, 115 VAC, to deliver electrical power to an electrical controller inside a housing 122 of a heat pump 126. Inside the base 14 is an electronic controller 130 that may transform, rectify, and filter the electric power so that direct current of the appropriate voltage is passed to magnetic repulsion connector 90 in the lower-most conduit 50 where it will be carried to the light strings on limbs 70 of artificial tree 10.

Heat generated by the electronic controller is dissipated vertically by heat pump 126 which directs air warmed by that heat up through housing 122 and on to conduits 50 and still further to the metal of limbs 70 of the artificial tree 10. It also radiates heat through the housing 122 and the legs 22 of base 14, which run through housing 122. The operation of heat pump 126 is disclosed and described in U.S. Pat. No. 9,033,777, cited above.

Those skilled in the art of artificial trees will appreciate that many substitutions and modification may be made in the aspects and features of the disclosure without departing from the spirit and scope of the appended claims.

1. An artificial tree, comprising:
(a) a base;
(b) a hollow trunk supported by said base and having an interior surfaced and an exterior surface
(c) plural hinge brackets carried by said exterior surface;
(d) plural limbs, each limb of said plural limbs being received by a hinge bracket of said plural hinge brackets, wherein hinge brackets of said plural hinge bracket are arranged in clusters on said exterior surface of said hollow trunk;
(e) a connection to electrical power;
(f) electrical power distribution system carried from said connection to electrical power through said interior of said hollow trunk to said each limb of said plural limbs; and
(g) lighting carried by said plural limbs and in operative connection with said connection to said electrical power distribution system.

2. The artificial tree of claim 1, further comprising a heat pump carried by said base.

3. The artificial tree of claim 1, further comprising:
(a) a heat pump carried by said base, said heat pump including a housing; and
(b) an electronic controller, said electronic controller being operable to receive electrical power from said connection, said electronic controller controlling and conditioning electricity delivered to said electrical power distribution system.

4. The artificial tree of claim 1, further comprising:
(a) a heat pump carried by said base, said heat pump including a housing, and wherein said base is made of a heat conducting material connected to said heat pump and is operable to dissipate said heat.

5. The artificial tree of claim 1, wherein said base comprising:
(a) plural legs; and
(b) plural eyebolts to attach said base to said hollow trunk.

6. The artificial tree of claim 1, wherein said hollow trunk further comprises plural conduits, a first conduit of said plural conduits joined to a second conduit of said plural conduits.

7. The artificial tree of claim 1, wherein said hollow trunk further comprises plural conduits, each first conduit of said plural conduits having a first end and a second end, and a second conduit of said plural conduits having a first end and a second end, said second end of said first conduit inserted into said first end of said second conduit.

8. The artificial tree of claim 1, wherein said hollow trunk further comprises plural conduits, each conduit of said plural conduits having a first end and a second end, and wherein said electrical power distribution system further comprises two magnetic repulsion connectors in said each conduit, a first magnetic repulsion connector in said first end of said each conduit and a second magnetic repulsion connector in said second end of said each conduit, said first magnetic repulsion connector electrically connected to said second magnetic repulsion connector.

9. The artificial tree of claim 1, wherein said hinge bracket of said plural hinge brackets pivotally holds a limb of said plural limbs, wherein said limb, when received by said hinge bracket has a first position close to said exterior surface of said trunk and a second position cantilevered with respect to said exterior surface of said trunk.

10. The artificial tree of claim 1, wherein said electrical power distribution system further comprising plural electrical conductors, and said lighting further comprises plural electrical light strings, and wherein said hollow trunk has plural holes formed therein permitting said plural electrical conductors to pass from said interior surface of said hollow trunk to said exterior surface of said hollow trunk and be connected to said plural electrical light strings, and wherein said plural electrical light strings are carried by said plural limbs.

11. An artificial tree, comprising:
(a) a base;
(b) a hollow trunk received by the base and having an interior surface and an exterior surface, said hollow trunk having plural holes formed therein,
(c) plural supports carried by said exterior surface of said hollow trunk, said plural supports being arranged in clusters on said exterior surface of said hollow trunk;
(c) plural limbs, each limb of said plural limbs being received by a support of said plural supports;
(d) a connection to electrical power;
(e) electrical power distribution system carried from said connection to electrical power through said interior of said hollow trunk and through said plural holes to said plural limbs; and
(f) lighting carried by said plural limbs and in operative connection with said connection to said electrical power distribution system.

12. The artificial tree of claim 11, wherein said hollow trunk further comprises plural conduits, each conduit of said plural conduits having a first end and a second end, and wherein said electrical power distribution system further comprises two magnetic repulsion connectors in said each conduit, a first magnetic repulsion connector in said first end of said each conduit and a second magnetic repulsion connector in said second end of said each conduit, said first magnetic repulsion connector electrically connected to said second magnetic repulsion connector.

13. The artificial tree of claim 11, wherein said electrical power distribution system comprises a plurality of electrical conductors extending from said base into said hollow trunk, and wherein at least one electrical conductor of said plural electrical conductors extends through a hole of said plural holes in said hollow trunk and is in operative connection with said lighting.

14. The artificial tree of claim 11, wherein said hollow trunk further comprises plural conduits, each conduit of said plural conduits having a first end and a second end, and wherein said electrical power distribution system further comprises two magnetic repulsion connectors in said each conduit of said plural conduits connected by a wiring harness including plural electrical wires, wherein at least one electrical wire of said plural electrical wires extends through a hole of said plural holes in said trunk to said lighting.

15. The artificial tree of claim 11, wherein said hollow trunk further comprises plural conduits, a first conduit of said plural conduits having a first end and a second end, and a second conduit of said plural conduits having a first end and a second end, and wherein said electrical power distribution system further comprises a first pair of magnetic repulsion connectors in said first electrical conduit and a second pair of magnetic repulsion connectors in said second conduit, said first pair of magnetic repulsion connectors connected by a first wiring harness, and said second pair of magnetic repulsion connectors connected by a second wiring harness, said first pair magnetic repulsion connectors of said first conduit being connected to said second pair magnetic repulsion connectors of said second conduit wherein electrical power is distributed through first conduit and said second conduit.

16. The artificial tree of claim 15, wherein said first wiring harness and said second wiring harness include of plural electrical wires and at least one wire of said plural electrical wires extends through each hole of said plural holes in said hollow trunk.

17. The artificial tree of claim 11, wherein each hole of said plural holes in said hollow trunk is fitted with a grommet.

18. An artificial tree, comprising:
(a) a base including at least three legs, and a central core, wherein each leg of said three legs extends radially and comprises surface-engaging feet, a framework made of a heat-conducting material;
(b) a hollow trunk received in said central core of said base, said trunk having an interior and an exterior;
(c) plural limbs, each limb of said plural limbs being carried on said exterior of said hollow trunk, said plural limbs being arranged in clusters on said exterior of said hollow trunk;
(d) a connection to electrical power;
(e) electrical power distribution system carried from said connection to electrical power through said interior of said hollow trunk and to said plural limbs; and
(f) lighting carried by said plural limbs and in operative connection with said connection to said electrical power distribution system.

19. The artificial holiday tree of claim 18, wherein said framework further comprises plural elements, including solid elements and hollow elements.

20. The artificial holiday tree of claim 18, wherein said framework is elevated above a surface engaged by said surface-engaging feet.
